(19) United States
(12) Patent Application Publication
(10) Pub. No.: US 2015/0036747 A1
(43) Pub. Date: Feb. 5, 2015

(54) ENCODING AND DECODING APPARATUS FOR CONCEALING ERROR IN VIDEO FRAME AND METHOD USING SAME

(71) Applicant: ELECTRONICS AND TELECOMMUNICATIONS RESEARCH INSTITUTE, Daejeon (KR)

(72) Inventors: Taewoo OH, Daejeon (KR); Kibom KIM, Cheongju-si (KR)

(21) Appl. No.: 14/444,374

(22) Filed: Jul. 28, 2014

(30) Foreign Application Priority Data
Jul. 30, 2013 (KR) 10-2013-0090206

(51) Int. Cl. H04N 19/51; H04N 19/89

(52) U.S. Cl. CPC H04N 19/00703; H04N 19/00939; H04N 19/00696
USPC 375/240.16

(57) ABSTRACT

An encoding apparatus and method for concealing an error in a video frame are provided. The encoding apparatus for concealing an error in a video frame includes a vector computation unit, a difference computation unit, and an information insertion unit. The vector computation unit computes a predicted motion vector (pMV) and a real motion vector (rMV) using a target macro block of a current frame and a motion-compensated block of a previous frame. The difference computation unit calculates a motion vector difference (MVD) using a difference between the pMV and the rMV. The information insertion unit inserts an information bit, including the MVD, into quantized discrete cosine transform (QDCT) coefficients of the video frame.

### CROSS REFERENCE TO RELATED APPLICATION

This application claims the benefit of Korean Patent Application No. 10-2013-0090206, filed Jul. 30, 2013, which is hereby incorporated by reference in its entirety into this application.

### BACKGROUND OF THE INVENTION

1. Technical Field

The present disclosure relates generally to an encoding and decoding apparatus for concealing an error in a video frame and a method using the encoding and decoding apparatus and, more particularly, to an encoding and decoding apparatus for concealing an error in a video frame using motion vector differences (MVDs) and a method using the encoding and decoding apparatus.

2. Description of the Related Art

Recently, data insertion-based error concealment technology has been widely used as video frame error concealment technology.

In general, in data insertion-based error concealment technology, data is inserted into an original moving image and then encoded. In a decoding process, an error is concealed using the inserted data. In the data insertion-based error concealment technology, the number of bits inevitably increases due to the insertion of data, which is connected directly with a disadvantage in that the amount of content increases. Accordingly, a reduction in bit increase rate has become an important consideration.

Korean Patent Application Publication No. 10-2002-0052220 discloses a method of compressing, sending, and receiving the image data of a high-pixel image using the Moving Picture Experts Group (MPEG) standard, and introduces a technology for concealing an error in a central screen using contour screen data.

Furthermore, “IEEE Transactions on Circuits Systems for Video Technology,” Vol. 19, No. 9, pp. 422 to 426 (published in March of 2009) introduces a technology for increasing the efficiency of error concealment in the macro block of an H.264/AVC intra frame, and “IEEE Transactions on Circuits Systems for Video Technology,” Vol. 20, No. 11, pp. 1643 to 1647 (published in December of 2010) introduces a technology for concealing an error by inserting reversible data into an intra frame.

However, those conventional technologies for concealing an error in a video frame use the surrounding pixels of a current image or a motion vector as data that has not been lost, but do not present a specific technology regarding how a bit increase rate can be reduced.

Accordingly, in order to realize the concealment of an error in a video frame that reduces a bit increase rate, there is an urgent need for a new video frame encoding/decoding technology for further reducing a bit increase rate attributable to the insertion of reversible data by inserting MVDs into QDCT coefficients.

### SUMMARY OF THE INVENTION

Accordingly, the present invention has been made keeping in mind the above problems occurring in the conventional art, and an object of the present invention is to enable video frame encoding/decoding capable of reducing a bit increase rate attributable to the insertion of reversible data using an MVD in the concealment of an error in a video frame.

Another object of the present invention is to enable video frame encoding/decoding capable of further reducing a bit increase rate attributable to the insertion of reversible data by inserting an MVD into QDCT coefficients.

Yet another object of the present invention is to enable video frame encoding/decoding capable of further reducing a bit increase rate attributable to the insertion of reversible data by inserting an information bit, including an MVD, between DC and AC coefficients that belong to QDCT coefficients.

Further yet another object of the present invention is to enable more precise video frame encoding/decoding by performing error concealment using 8×8 mode if a distortion cost in 16×16 mode is high.

In accordance with an aspect of the present invention, there is provided an encoding apparatus for concealing an error in a video frame, including a vector computation unit configured to compute a predicted motion vector (pMV) and a real motion vector (rMV) using a target macro block of a current frame and a motion-compensated block of a previous frame; a difference computation unit configured to calculate a motion vector difference (MVD) using a difference between the pMV and the rMV; and an information insertion unit configured to insert an information bit, including the MVD, into quantized discrete cosine transform (QDCT) coefficients of the video frame.

The vector computation unit may include a prediction vector computation unit configured to compute the pMV using a sum of absolute differences (SAD) between surrounding pixels of the target macro block of the current frame and internal pixels of the motion-compensated block of the previous frame; and a real vector computation unit configured to compute the rMV using an SAD between internal pixels of the target macro block of the current frame and the internal pixels of the motion-compensated block of the previous frame.

The prediction vector computation unit may compute the pMV by taking into consideration whether or not an SAD between the surrounding pixels of the target macro block of the current frame and surrounding pixels of the motion-compensated block of the previous frame is a minimum value.

The real vector computation unit may compute the rMV by taking into consideration whether or not the SAD between the internal pixels of the target macro block of the current frame and the internal pixels of the motion-compensated block of the previous frame is smaller than a predetermined distortion threshold.

The real vector computation unit may compute the rMV by further taking into consideration whether or not a number of “1” bits within a binary sequence of the MVD is a minimum value.

The vector computation unit may further include an 8×8 vector computation unit configured to compute an 8×8 motion vector using surrounding pixels of an 8×8 block within the target macro block of the current frame; the encoding apparatus may further include a distortion cost calculation unit configured to calculate a distortion cost of the rMV and the 8×8 motion vector; and the information insertion unit may insert the information bit, including any one of the MVD and an 8×8 mode identifier corresponding to the 8×8 motion vector, into the QDCT coefficients based on the distortion cost.

The information insertion unit may insert the information bit between DC and AC coefficients that belong to the QDCT coefficients.

In accordance with an aspect of the present invention, there is provided a decoding apparatus for concealing an error in a video frame, including an information acquisition unit configured to obtain an information bit from the video frame in which the information bit, including a motion vector difference (MVD), has been inserted into quantized discrete cosine transform (QDCT) coefficients and on which encoding has been performed; a vector computation unit configured to compute a predicted motion vector (pMV) and a real motion vector (rMV) using a target macro block of a current frame, a motion-compensated block of a previous frame, and the MVD; and an error concealment unit configured to perform the concealment of the error in the video frame using the rMV.

The vector computation unit may include a prediction vector computation unit configured to compute the pMV using a sum of absolute differences (SAD) between surrounding pixels of the target macro block of the current frame and internal pixels of the motion-compensated block of the previous frame; and a real vector computation unit configured to compute the rMV using a sum of the pMV and the MVD.

The information acquisition unit may determine whether or not an 8×8 mode identifier is included in the information bit; the vector computation unit further comprise an 8×8 vector computation unit configured to compute an 8×8 motion vector using the surrounding pixels of the target macro block of the current frame if, as a result of the determination, it is determined that the 8×8 mode identifier is included in the information bit; and the error concealment unit conceals the error in the video frame using the 8×8 motion vector if, as a result of the determination, it is determined that the 8×8 mode identifier is included in the information bit.

In accordance with another aspect of the present invention, there is provided an encoding method for concealing an error in a video frame, including computing a predicted motion vector (pMV) and a real motion vector (rMV) using a target macro block of a current frame and a motion-compensated block of a previous frame; calculating a motion vector difference (MVD) using a difference between the pMV and the rMV; and inserting an information bit, including the MVD, into quantized discrete cosine transform (QDCT) coefficients of the video frame.

Computing the pMV and the rMV may include computing the pMV using a sum of absolute differences (SAD) between surrounding pixels of the target macro block of the current frame and internal pixels of the motion-compensated block of the previous frame; and computing the rMV using an SAD between internal pixels of the target macro block of the current frame and the internal pixels of the motion-compensated block of the previous frame.

Computing the pMV and the rMV may further include computing the pMV by taking into consideration whether or not an SAD between the surrounding pixels of the target macro block of the current frame and surrounding pixels of the motion-compensated block of the previous frame is a minimum value.

Computing the pMV and the rMV may include computing the rMV by taking into consideration whether or not the SAD between the internal pixels of the target macro block of the current frame and the internal pixels of the motion-compensated block of the previous frame is smaller than a predetermined distortion threshold.

Computing the pMV and the rMV may include computing the rMV by further taking into consideration whether or not a number of “1” bits within a binary sequence of the MVD is a minimum value.

The encoding method may further include computing an 8×8 motion vector using surrounding pixels of an 8×8 block within the target macro block of the current frame, and calculating a distortion cost of the rMV and the 8×8 motion vector; and inserting the information bit may include inserting the information bit, including any one of the MVD and an 8×8 mode identifier corresponding to the 8×8 motion vector, into the QDCT coefficients based on the distortion cost.

Inserting the information bit may include inserting the information bit between DC and AC coefficients that belong to the QDCT coefficients.

In accordance with another aspect of the present invention, there is provided a decoding method for concealing an error in a video frame, including obtaining an information bit from a video frame in which the information bit, including a motion vector difference (MVD), has been inserted into quantized discrete cosine transform (QDCT) coefficients and on which encoding has been performed; computing a predicted motion vector (pMV) and a real motion vector (rMV) using a target macro block of a current frame, a motion-compensated block of a previous frame, and the MVD; and concealing the error in the video frame using the rMV.

Computing the pMV and the rMV may include computing the pMV using a sum of absolute differences (SAD) between surrounding pixels of the target macro block of the current frame and internal pixels of the motion-compensated block of the previous frame; and computing the rMV using a sum of the pMV and the MVD.

Obtaining the information bit may include determining whether or not an 8×8 mode identifier is included in the information bit; the decoding method may further include computing an 8×8 motion vector using the surrounding pixels of the target macro block of the current frame if, as a result of the determination, it is determined that the 8×8 mode identifier is included in the information bit; and performing the concealment of the error may include performing the concealment of the error in the video frame using the 8×8 motion vector if, as a result of the determination, it is determined that the 8×8 mode identifier is included in the information bit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an encoding apparatus for concealing an error in a video frame according to an embodiment of the present invention;

FIG. 2 is a block diagram illustrating an example of a system to which the encoding apparatus for concealing an error in a video frame according to an embodiment of the present invention has been applied;

FIG. 3 is a block diagram illustrating a decoding apparatus for concealing an error in a video frame according to an embodiment of the present invention;

FIG. 4 is a block diagram illustrating an example of a system to which the decoding apparatus for concealing an error in a video frame according to an embodiment of the present invention has been applied;

FIG. 5 is a diagram illustrating an example in which an information insertion unit of FIG. 1 inserts an information bit into DCT coefficients;

FIG. 6 is a diagram illustrating an example of the binary sequences of MVDs according to an embodiment of the present invention;

FIG. 7 is a diagram illustrating an example of the surrounding pixels of a 16×16 block according to an embodiment of the present invention;

FIG. 8 is a diagram illustrating an example of the internal pixels of a 16×16 block according to an embodiment of the present invention;

FIGS. 9A to 9D are diagrams illustrating examples of the surrounding pixels of 8×8 blocks according to an embodiment of the present invention;

FIG. 10 is a flowchart illustrating an encoding method of concealing an error in a video frame according to an embodiment of the present invention; and

FIG. 11 is a flowchart illustrating a decoding method of concealing an error in a video frame according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Embodiments of the present invention are described in detail below with reference to the accompanying drawings.

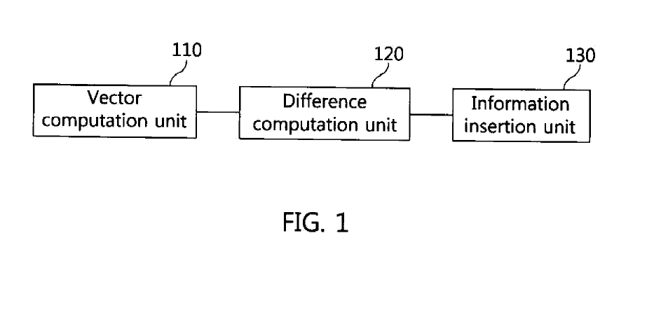

FIG. 1 is a block diagram illustrating an encoding apparatus for concealing an error in a video frame according to an embodiment of the present invention.

Referring to FIG. 1, the encoding apparatus for concealing an error in a video frame according to this embodiment of the present invention includes a vector computation unit 110, a difference computation unit 120, and an information insertion unit 130.

The vector computation unit 110 computes a predicted motion vector (pMV) and a real motion vector (rMV) using a target macro block of a current frame and a motion-compensated block of a previous frame.

In this case, the vector computation unit 110 may include a prediction vector computation unit configured to compute the pMV using the Sum of Absolute Differences (SAD) between the surrounding pixels of the target macro block of the current frame and the internal pixels of the motion-compensated block of the previous frame; and a real vector computation unit configured to compute the rMV using the SAD between the internal pixels of the target macro block of the current frame and the internal pixels of the motion-compensated block of the previous frame.

In this case, the prediction vector computation unit may compute the pMV by taking into consideration whether or not the SAD between the surrounding pixels of the target macro block of the current frame and the surrounding pixels of the motion-compensated block of the previous frame is a minimum value.

In this case, the surrounding pixels of the target macro block of the current frame and the surrounding pixels of the motion-compensated block of the previous frame may have been obtained by a video frame pre-processing unit.

In this case, the prediction vector computation unit may compute the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by the following Equation 1:

$${SAD}_{pMV} ( {pMV}_{x} , {pMV}_{y} ) = {\sum }_{i = 0}^{15} [ \vert p ( x + i , y - 1 , t ) - {p}_{r} ( x + i + {pMV}_{x} , y - 1 + {pMV}_{y} , t - 1 ) \vert + \vert p ( x + i , y + 16 , t ) - {p}_{r} ( x + i + {pMV}_{x} , y + 16 + {pMV}_{y} , t - 1 ) \vert + \vert p ( x - 1 , y + i , t ) - {p}_{r} ( x - 1 + {pMV}_{x} , y + i + {pMV}_{y} , t - 1 ) \vert + \vert p ( x + 16 , y + i , t ) - {p}_{r} ( x + 16 + {pMV}_{x} , y + i + {pMV}_{y} , t - 1 ) \vert \vert \qquad ( 1 )$$

In this case, SAD_{pMV} is the SAD between the surrounding pixels of the target macro block of the current frame and the surrounding pixels of the motion-compensated block of the previous frame, p is a pixel value, pᵣ is a motion-compensated pixel value, pMVₓ is the x coordinate value of the pMV, pMV_{y}, is the y coordinated value of the pMV, t is the current frame, and t−1 is the previous frame.

In this case, the pMV for which the SAD between the surrounding pixels of the target macro block of the current frame and the surrounding pixels of the motion-compensated block of the previous frame is a minimum value may be expressed by the following Equation 2:

$$( {pMV}_{min , x} , {pMV}_{min , y} ) = arg {min}_{{pMV}_{x} , {pMV}_{y}} ⌊ {SAD}_{pMV} ( {pMV}_{x} , {pMV}_{y} ) ⌋ \qquad ( 2 )$$

In this case, the prediction vector computation unit may compute the pMV in accordance with a hierarchical fractional pixel search (HFPS) algorithm.

In this case, the prediction vector computation unit may compute the pMV with the accuracy of a half pixel in a range of −15 to +15.

In this case, the real vector computation unit may compute the rMV by taking into consideration whether or not the SAD between the internal pixels of the target macro block of the current frame and the internal pixels of the motion-compensated block of the previous frame is smaller than a predetermined distortion threshold.

In this case, the internal pixels of the target macro block of the current frame and the internal pixels of the motion-compensated block of the previous frame may have been obtained by the video frame pre-processing unit.

In this case, the real vector computation unit may compute the rMV for which the SAD between the internal pixels of the target macro block of the current frame and the internal pixels of the motion-compensated block of the previous frame is smaller than a predetermined distortion threshold.

In this case, the SAD between the internal pixels of the target macro block of the current frame and the internal pixels of the motion-compensated block of the previous frame may be expressed by the following Equation 3:

$${SAD}_{rMV} ( {rMV}_{x} , {rMV}_{y} ) = {\sum }_{i = 0}^{15} {\sum }_{j = 0}^{15} [ \vert p ( x + i , y + j , t ) - {p}_{r} ( x + i + {rMV}_{x} , y + j + {rMV}_{y} , t - 1 ) \vert ] \qquad ( 3 )$$

In this case, SAD_{rMV} is the SAD between the internal pixels of the target macro block of the current frame and the internal pixels of the motion-compensated block of the previous frame, p is a pixel value, pᵣ is a motion-compensated pixel value, rMVₓ is the x coordinate value of the rMV, rMV_{y} is the y coordinated value of the rMV, t is the current frame, and t−1 is the previous frame.

In this case, the rMV for which the SAD between the internal pixels of the target macro block of the current frame and the internal pixels of the motion-compensated block of the previous frame is smaller than a predetermined distortion threshold may be expressed by the following Equation 4:

$$( \overline{{rMV}_{x}} , \overline{{rMV}_{y}} ) = \{ ( {rMV}_{x} , {rMV}_{y} ) \vert \vert {min}_{{rMV}_{x} , {rMV}_{y}} [ {SAD}_{rMV} ( {rMV}_{x} , {rMV}_{y} ) ] - {SAD}_{rMV} ( {rMV}_{x} , {rMV}_{y} ) \vert < TH and arg {min}_{{rMV}_{x} , {rMV}_{y}} [ \begin{matrix}{SAD}_{rMV} ( {rMV}_{x} , {rMV}_{y} ) + \\ TH \times R ( {rMV}_{x} , {rMV}_{y} )\end{matrix} ] \} \qquad ( 4 )$$

In this case, Th is the predetermined distortion threshold, and R is a bit increase rate.

In this case, the real vector computation unit may compute the rMV by further taking into consideration whether or not the number of “1” bits within the binary sequence of an MVD is a minimum value.

In this case, R may be expressed by the following Equation 5:

R(rMVₓ,rMV_{y})=C(rMVₓ−pMV_{min,x})+C(rMV_{y}−pMV_{min,y}) (5)

In this case, C is the number of “1” bits within the binary sequence of the MVD.

In this case, the number of “1” bits within the binary sequence of the MVD may have a one-to-one correspondence relationship with the MVD.

In this case, the real vector computation unit may compute the rMV in accordance with the HFPS algorithm.

In this case, the real vector computation unit may compute the rMV with the accuracy of a half pixel in a range of −15 to +15.

The difference computation unit 120 calculates the MVD using the difference between the pMV and the rMV.

In this case, the MVD may be expressed by the following Equation 6:

(MVDₓ,MVD_{y})=( r̅M̅V̅ₓ̅−pMV_{min,x}, r̅M̅V̅_̅{̅y̅}̅−pMV_{min,y}) (6)

In this case, MVDₓ is the x-axis component of the MVD, and MVD_{y} is the y-axis component of the MVD.

The information insertion unit 130 inserts an information bit, including the MVD, into the Quantized Discrete Transform (QDCT) coefficients of a video frame.

In this case, the QDCT coefficients may have been obtained by the video frame pre-processing unit.

In this case, the QDCT coefficients may have been rearranged in a zigzag pattern by the video frame pre-processing unit.

In this case, the information insertion unit 130 may insert the information bit between the DC and AC coefficients of the QDCT coefficients.

In this case, the DC coefficient may be a coefficient that belongs to the QDCT coefficients and that has a frequency of 0.

In this case, the AC coefficient may be a coefficient that belongs to the QDCT coefficients and that does not have a frequency of 0.

In this case, the QDCT coefficient may be a coefficient corresponding to the frequency parameter of DCT.

In this case, if the QDCT coefficient is C and the frequency parameter of DCT is k, the QDCT coefficient corresponding to the frequency parameter may be C(k).

In this case, the DC coefficient may be C(0).

In this case, the AC coefficient may be C(k) in which k is not 0.

In this case, the information insertion unit 130 may insert the information bit into the QDCT coefficients using a histogram shift-based reversible data concealment scheme.

In this case, if the frequency parameter is a positive number, the information insertion unit 130 may set the frequency parameter so that it is increased by 1, may set the frequency parameter of the information bit so that it is 1, and may insert the information bit between the DC and AC coefficients. This may be expressed by the following Equation 7:

$$k = \{ \begin{matrix}k , & k \leq 0 and b = 0 \\ k + 1 , & k > 0 and b = 0 \\ 1 , & b = 1\end{matrix} \qquad ( 7 )$$

In this case, k is the frequency parameter, and b is an index used to distinguish the QDCT coefficient and the information bit.

In this case, b corresponds to 0 when a value corresponding to k is the QDCT coefficient.

In this case, b corresponds to 1 when a value corresponding to k is the information bit.

As described above, in accordance with Equation 7, the information insertion unit 130 may set k so that it is increased by 1 if k is a positive number and a value corresponding to k is the QDCT coefficient, may set k so that it is 1 if the value corresponding to k is the information bit, and may insert the information bit between the DC and AC coefficients.

In this case, the information insertion unit 130 may transfer the QDCT coefficients, into which the information bit has been inserted, to an entropy encoding unit.

In this case, the entropy encoding unit may encode the QDCT coefficients, into which the information bit has been inserted, using the chessboard pattern mode of flexible macro block ordering (FMO) with respect to H.264/AVC.

In this case, the vector computation unit 110 may further include an 8×8 vector computation unit configured to compute an 8×8 motion vector using the surrounding pixels of an 8×8 block within the target macro block of the current frame.

In this case, the surrounding pixels of the 8×8 block within the target macro block of the current frame may have been obtained by the video frame pre-processing unit.

In this case, if the target macro block of the current frame is a 16×16 block, the 8×8 vector computation unit may compute the 8×8 motion vector of each of four 8×8 blocks that are included in the 16×16 block without overlapping each other.

In this case, the 8×8 vector computation unit may compute the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by the following Equation 8:

$${SAD}_{( k )} ⌊ {MV}_{x} ( k ) , {MV}_{y} ( k ) ⌋ = {\sum }_{i = 0}^{m - 1} {\sum }_{j = 0}^{n - 1} \vert p ( {x}_{k} + i , {y}_{k} + j , t ) - {p}_{r} ( {x}_{k} + i + {MV}_{x} ( k ) , {y}_{k} + j + {MV}_{y} ( k ) , t - 1 ) \vert + {\sum }_{i = 0}^{n - 1} {\sum }_{j = 0}^{m - 1} \vert p ( {x}_{k}^{′} + i , {y}_{k}^{′} + j , t ) - {p}_{r} ( {x}_{k}^{′} + i + {MV}_{x} ( k ) , {y}_{k}^{′} + j + {MV}_{y} ( k ) , t - 1 ) \vert \qquad ( 8 )$$

In this case, k is an index used to distinguish the 8×8 motion vectors in raster scan order, each of m and n is the length of an integer that determines the range of surrounding pixels of the 8×8 block, p is a pixel value, pᵣ is a motion-compensated pixel value, MVₓ is the x coordinate value of the 8×8 motion vector, MV_{y} is the y coordinated value of the 8×8 motion vector, t is the current frame, and t−1 is the previous frame.

In this case, k may be any one of 0, 1, 2 and 3.

For example, m may be 10, and n may be 5.

In this case, the 8×8 motion vector for which the SAD between the surrounding pixels of the 8×8 block of the current frame and the surrounding pixels of the motion-compensated 8×8 block of the previous frame is a minimum value may be expressed by the following Equation 9:

$$( {MV}_{min , x} ( k ) , {MV}_{min , y} ( k ) ) = arg {min}_{{MV}_{x} ( k ) , {MV}_{y} ( k )} \{ {SAD}_{( k )} ⌊ {MV}_{x} ( k ) , {MV}_{y} ( k ) ⌋ \} \qquad ( 9 )$$

Although not illustrated in FIG. 1, the encoding apparatus for concealing an error in a video frame may further include a distortion cost calculation unit configured to calculate the distortion cost of the rMV and the 8×8 motion vector.

In this case, the distortion cost calculation unit may calculate a distortion cost in an MVD embedding (E) mode using the SAD of the rMV.

The distortion cost in an MVD E mode may be expressed by the following Equation 10:

DC_{MVD}_{_{—}}_{E}=SAD_{rMV}( r̅M̅V̅ₓ̅, r̅M̅V̅_̅{̅y̅}̅) (10)

In this case, the distortion cost calculation unit may calculate a distortion cost in an MVD non-embedding (NE) mode using the SAD of the 8×8 motion vector.

The distortion cost in an MVD NE mode may be expressed by the following Equation 11:

$${DC}_{MVD \_ NE} = {\sum }_{k = 0}^{3} {SAD}_{( k )} [ {MV}_{min , x} ( k ) , {MV}_{min , y} ( k ) ] \qquad ( 11 )$$

In this case, the information insertion unit 130 may insert an information bit, including any one of the MVD and an 8×8 mode identifier corresponding to the 8×8 motion vector, into the QDCT coefficients based on the distortion cost.

In this case, if the distortion cost in an MVD E mode is higher than the distortion cost in an MVD NE mode, the information insertion unit 130 may insert the information bit, including the MVD, into the QDCT coefficients.

In this case, if the distortion cost in an MVD E mode is lower than the distortion cost in an MVD NE mode, the information insertion unit 130 may insert the information bit, including the 8×8 mode identifier corresponding to the 8×8 motion vector, into the QDCT coefficients.

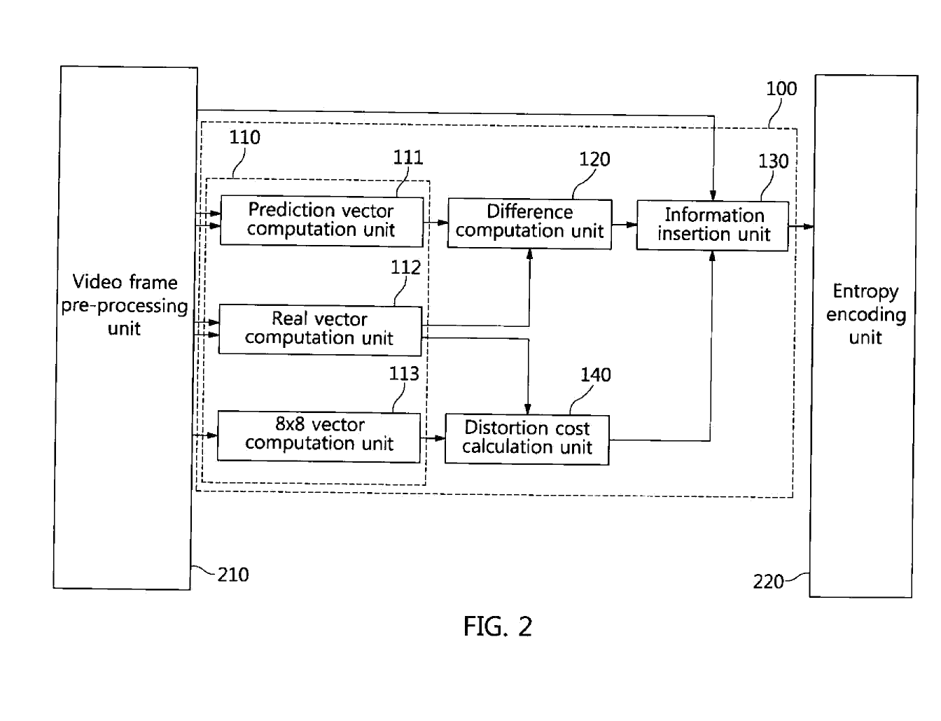

FIG. 2 is a block diagram illustrating an example of a system to which the encoding apparatus for concealing an error in a video frame according to an embodiment of the present invention has been applied.

Referring to FIG. 2, the system to which the encoding apparatus for concealing an error in a video frame according to an embodiment of the present invention has been applied includes the video frame pre-processing unit 210, the encoding apparatus 100, and the entropy encoding unit 220.

The video frame pre-processing unit 210 transfers information about pixels and information about QDCT coefficients to the encoding apparatus 100.

In this case, the video frame pre-processing unit 210 may transfer the surrounding pixels of the target macro block of the current frame and the surrounding pixels of the motion-compensated block of the previous frame to the prediction vector computation unit 111 of the encoding apparatus 100.

In this case, the video frame pre-processing unit 210 may transfer the internal pixels of the target macro block of the current frame and the internal pixels of the motion-compensated block of the previous frame to the real vector computation unit 112 of the encoding apparatus 100.

In this case, the video frame pre-processing unit 210 may transfer the surrounding pixels of an 8×8 block within the target macro block of the current frame to the 8×8 vector computation unit 113 of the encoding apparatus 100.

In this case, the video frame pre-processing unit 210 may transfer the QDCT coefficients to the information insertion unit 130 of the encoding apparatus 100.

In this case, the video frame pre-processing unit 210 may rearrange the QDCT coefficients in a zigzag pattern, and may transfer the rearranged QDCT coefficients to the information insertion unit 130.

The encoding apparatus 100 includes the vector computation unit 110, the difference computation unit 120, and the information insertion unit 130.

The vector computation unit 110 may compute a pMV and an rMV using the target macro block of the current frame and the motion-compensated block of the previous frame.

The vector computation unit 110 may include the prediction vector computation unit 111 configured to compute the pMV using the SAD between the surrounding pixels of the target macro block of the current frame and the internal pixels of the motion-compensated block of the previous frame; the real vector computation unit 112 configured to compute the rMV using the SAD between the internal pixels of the target macro block of the current frame and the internal pixels of the motion-compensated block of the previous frame; and the 8×8 vector computation unit 113 configured to compute the 8×8 motion vector using the surrounding pixels of the 8×8 block within the target macro block of the current frame.

In this case, the prediction vector computation unit 111 may compute the pMV by taking into consideration whether or not the SAD between the surrounding pixels of the target macro block of the current frame and the surrounding pixels of the motion-compensated block of the previous frame is a minimum value.

In this case, the prediction vector computation unit 111 may compute the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

In this case, the pMV for which the SAD between the surrounding pixels of the target macro block of the current frame and the surrounding pixels of the motion-compensated block of the previous frame is a minimum value may be expressed by Equation 2.

In this case, the prediction vector computation unit 111 may compute the pMV in accordance with the HFPS algorithm.

In this case, the prediction vector computation unit 111 may compute the pMV with the accuracy of a half pixel in a range of −15 to +15.

In this case, the real vector computation unit 112 may compute the rMV by taking into consideration whether or not the SAD between the internal pixels of the target macro block of the current frame and the internal pixels of the motion-compensated block of the previous frame is smaller than a predetermined distortion threshold.

In this case, the real vector computation unit 112 may compute the rMV for which the SAD between the internal pixels of the target macro block of the current frame and the internal pixels of the motion-compensated block of the previous frame is smaller than the predetermined distortion threshold.

In this case, the SAD between the internal pixels of the target macro block of the current frame and the internal pixels of the motion-compensated block of the previous frame may be expressed by Equation 3.

In this case, the rMV for which the SAD between the internal pixels of the target macro block of the current frame and the internal pixels of the motion-compensated block of the previous frame is smaller than the predetermined distortion threshold may be expressed by Equation 4.

In this case, the real vector computation unit 112 may compute the rMV by further taking into consideration whether or not the number of “1” bits within the binary sequence of an MVD is a minimum value.

In this case, R may be expressed by Equation 5.

In this case, the number of “1” bits within the binary sequence of the MVD may have a one-to-one correspondence relationship with the MVD.

In this case, the real vector computation unit 112 may compute the rMV in accordance with the HFPS algorithm.

In this case, the real vector computation unit 112 may compute the rMV within the accuracy of a half pixel in a range of −15 to +15.

The difference computation unit 120 calculates the MVD using the difference between the pMV and the rMV.

In this case, the MVD may be expressed by Equation 6.

The information insertion unit 130 inserts an information bit, including the MVD, into the QDCT coefficients of the video frame.

In this case, the information insertion unit 130 may insert the information bit between DC and AC coefficients that belong to the QDCT coefficients.

In this case, the DC coefficient may be a coefficient that belongs to the QDCT coefficients and that has a frequency of 0.

In this case, the AC coefficient may be a coefficient that belongs to the QDCT coefficients and that does not have a frequency of 0.

In this case, the QDCT coefficient may be a coefficient corresponding to the frequency parameter of DCT.

In this case, if the QDCT coefficient is C and the frequency parameter of the DCT is k, the QDCT coefficient corresponding to the frequency parameter may be C(k).

In this case, the DC coefficient may be C(0).

In this case, the AC coefficient may be C(k) in which k is not 0.

In this case, the information insertion unit 130 may insert the information bit into the QDCT coefficients using a histogram shift-based reversible data concealment scheme.

In this case, if the frequency parameter is a positive number, the information insertion unit 130 may set the frequency parameter so that it is increased by 1, may set the frequency parameter of the information bit so that it becomes 1, and may insert the information bit between the DC and AC coefficients. This may be expressed by Equation 7.

As described above, in accordance with Equation 7, the information insertion unit 130 may set k so that it is increased by 1 if k is a positive number and a value corresponding to k is the QDCT coefficient, may set k so that it becomes 1 if the value corresponding to k is the information bit, and may insert the information bit between the DC and AC coefficients.

In this case, the information insertion unit 130 may transfer the QDCT coefficients, into which the information bit has been inserted, to the entropy encoding unit 220.

The entropy encoding unit 220 may encode the QDCT coefficients, into which the information bit has been inserted, using the chessboard pattern mode of FMO with respect to H.264/AVC.

In this case, if the target macro block of the current frame is a 16×16 block, the 8×8 vector computation unit 113 may compute the 8×8 motion vector of each of four 8×8 blocks that are included in the 16×16 block without overlapping each other.

In this case, the 8×8 vector computation unit 113 may compute the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

In this case, the 8×8 motion vector for which the SAD between the surrounding pixels of the 84 block of the current frame and the surrounding pixels of the motion-compensated 8×8 block of the previous frame is a minimum value may be expressed by Equation 9.

Furthermore, the encoding apparatus 100 may further include the distortion cost calculation unit 140 configured to the distortion costs of the rMV and the 8×8 motion vector.

In this case, the distortion cost calculation unit 140 may calculate a distortion cost in an MVD E mode using the SAD of the rMV.

In this case, the distortion cost in an MVD E mode may be expressed by Equation 10.

In this case, the distortion cost calculation unit 140 may calculate a distortion cost in an MVD NE mode using the SAD of the 8×8 motion vector.

In this case, the distortion cost in an MVD NE mode may be expressed by Equation 11.

In this case, the information insertion unit 130 may insert an information bit, including any one of the MVD and an 8×8 mode identifier corresponding to the 8×8 motion vector, into the QDCT coefficients based on the distortion cost.

In this case, if the distortion cost in an MVD E mode is higher than the distortion cost in an MVD NE mode, the information insertion unit 130 may insert the information bit, including the MVD, into the QDCT coefficients.

In this case, if the distortion cost in an MVD E mode is lower than the distortion cost in an MVD NE mode, the information insertion unit 130 may insert the information bit, including the 8×8 mode identifier corresponding to the 8×8 motion vector, into the QDCT coefficients.

The entropy encoding unit 220 encodes the QDCT coefficients, into which the information bit has been inserted, using the chessboard pattern mode of FMO with respect to H.264/AVC.

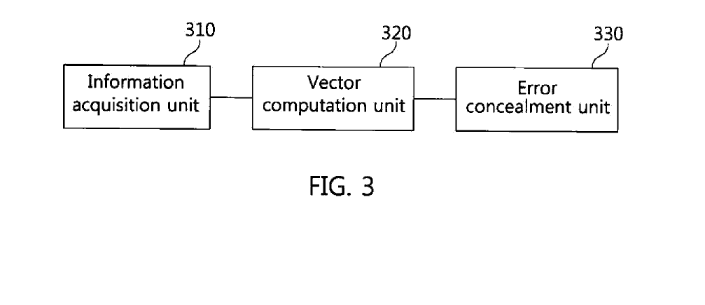

FIG. 3 is a block diagram illustrating a decoding apparatus for concealing an error in a video frame according to an embodiment of the present invention.

Referring to FIG. 3, the decoding apparatus for concealing an error in a video frame according to this embodiment of the present invention includes an information acquisition unit 310, a vector computation unit 320, and an error concealment unit 330.

The information acquisition unit 310 obtains an information bit from the video frame in which the information bit, including an MVD, has been inserted into QDCT coefficients and on which encoding has been performed.

In this case, the information bit may have been obtained by an entropy decoding unit.

The vector computation unit 320 computes a pMV and an rMV using a target macro block of a current frame, a motion-compensated block of a previous frame, and the MVD.

In this case, the vector computation unit 320 may include a prediction vector computation unit configured to compute the pMV using the SAD between the surrounding pixels of the target macro block of the current frame and the internal pixels of the motion-compensated block of the previous frame; and a real vector computation unit configured to compute the rMV using the sum of the pMV and the MVD.

In this case, the prediction vector computation unit may compute the pMV by taking into consideration whether or not the SAD between the surrounding pixels of the target macro block of the current frame and the surrounding pixels of the motion-compensated block of the previous frame is a minimum value.

In this case, the surrounding pixels of the target macro block of the current frame and the surrounding pixels of the motion-compensated block of the previous frame may have been obtained by the entropy decoding unit.

In this case, the prediction vector computation unit may compute the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

In this case, the pMV for which the SAD between the surrounding pixels of the target macro block of the current frame and the surrounding pixels of the motion-compensated block of the previous frame is a minimum value may be expressed by Equation 2.

In this case, the prediction vector computation unit may compute the pMV in accordance with the HFPS algorithm.

In this case, the prediction vector computation unit may compute the pMV with the accuracy of a half pixel in a range of −15 to +15.

In this case, the real vector computation unit may compute the rMV using the MVD and the pMV.

For example, the real vector computation unit may compute the rMV by adding the MVD and the pMV.

The error concealment unit 330 conceals an error in the video frame using the rMV.

In this case, the error concealment unit 330 may transfer the video frame, in which the error has been concealed, to a video frame provision unit.

In this case, the vector computation unit 320 may further include an 8×8 vector computation unit configured to determine whether or not an 8×8 mode identifier is included in the information bit and to compute an 8×8 motion vector using the surrounding pixels of the target macro block of the current frame if, as a result of the determination, it is determined that the 8×8 mode identifier is included in the information bit.

In this case, if the target macro block of the current frame is a 16×16 block, the 8×8 vector computation unit may compute the 84 motion vector of each of four 8×8 blocks that are included in the 16×16 block without overlapping each other.

In this case, the surrounding pixels of the 8×8 block within the target macro block of the current frame may have been obtained by the entropy decoding unit.

In this case, the 8×8 vector computation unit may compute the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

In this case, the 8×8 motion vector for which the SAD between the surrounding pixels of the 84 block of the current frame and the surrounding pixels of the motion-compensated 8×8 block of the previous frame is a minimum value may be expressed by Equation 9.

In this case, the information acquisition unit 310 may obtain an information bit from a video frame in which the information bit, including any one of the MVD and an 8×8 mode identifier corresponding to the 8×8 motion vector, has been inserted into the QDCT coefficients according to a distortion cost and on which encoding has been performed.

In this case, if the information bit includes the MVD, the vector computation unit 320 may compute the pMV and the rMV.

In this case, if the information bit includes the 8×8 mode identifier, the vector computation unit 320 may compute the 8×8 motion vector.

In this case, if the information bit includes the 8×8 mode identifier, the error concealment unit 330 may conceal an error in the video frame using the 8×8 motion vector.

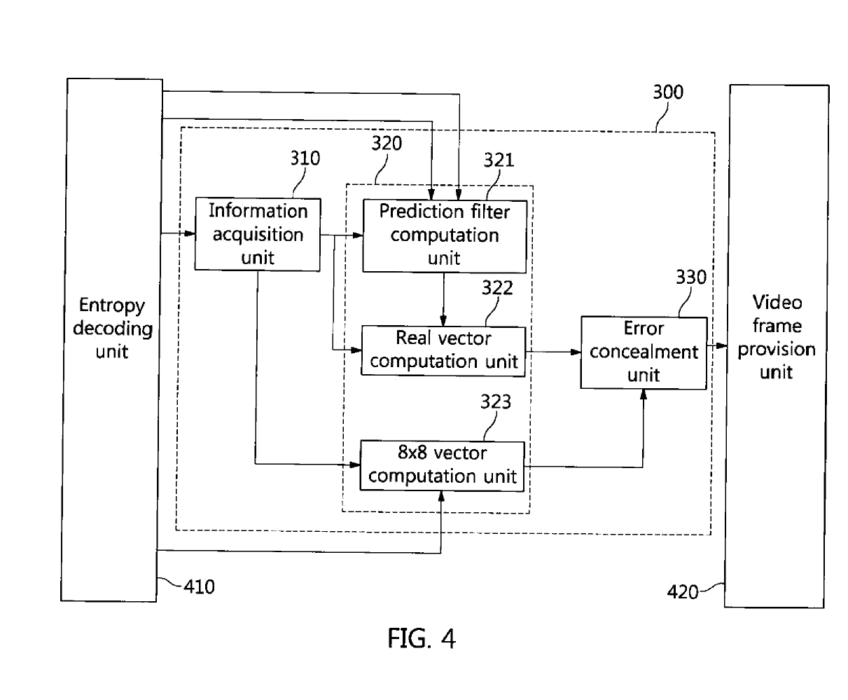

FIG. 4 is a block diagram illustrating an example of a system to which the decoding apparatus for concealing an error in a video frame according to an embodiment of the present invention has been applied.

Referring to FIG. 4, the system to which the decoding apparatus for concealing an error in a video frame according to this embodiment of the present invention has been applied includes the entropy decoding unit 410, the decoding apparatus 300, and the video frame provision unit 420.

The entropy decoding unit 410 transfers an information bit, including information about pixels and an MVD, to the decoding apparatus 300.

In this case, the entropy decoding unit 410 may transfer the information bit to the information acquisition unit 310 of the decoding apparatus 300.

In this case, the entropy decoding unit 410 may transfer the surrounding pixels of the target macro block of the current frame and the surrounding pixels of the motion-compensated block of the previous frame to the prediction filter computation unit 321 of the decoding apparatus 300.

In this case, the entropy decoding unit 410 may transfer the surrounding pixels of the 8×8 block within the target macro block of the current frame to the 8×8 vector computation unit 323 of the decoding apparatus 300.

The decoding apparatus 300 includes the information acquisition unit 310, the vector computation unit 320, and the error concealment unit 330.

The information acquisition unit 310 obtains an information bit from a video frame in which the information bit, including an MVD, has been inserted into QDCT coefficients and on which encoding has been performed.

In this case, the information bit may have been obtained by the entropy decoding unit 410.

The vector computation unit 320 computes a pMV and an rMV using the target macro block of the current frame, the motion-compensated block of the previous frame, and the MVD.

In this case, the vector computation unit 320 may include the prediction vector computation unit 321 configured to compute the pMV using the SAD between the surrounding pixels of the target macro block of the current frame and the internal pixels of the motion-compensated block of the previous frame; the real vector computation unit 322 configured to compute the rMV using the sum of the pMV and the MVD; and the 8×8 vector computation unit 323 configured to determine whether or not an 8×8 mode identifier is included in the information bit and to compute an 8×8 motion vector using the surrounding pixels of the target macro block of the current frame if, as a result of the determination, it is determined that the 8×8 mode identifier is included in the information bit.

In this case, the prediction vector computation unit 321 may compute the pMV by taking into consideration whether or not the SAD between the surrounding pixels of the target macro block of the current frame and the surrounding pixels of the motion-compensated block of the previous frame is a minimum value.

In this case, the surrounding pixels of the target macro block of the current frame and the surrounding pixels of the motion-compensated block of the previous frame may have been obtained by the entropy decoding unit 410.

In this case, the prediction vector computation unit 321 may compute the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

In this case, the pMV for which the SAD between the surrounding pixels of the target macro block of the current frame and the surrounding pixels of the motion-compensated block of the previous frame is a minimum value may be expressed by Equation 2.

In this case, the prediction vector computation unit 321 may compute the pMV in accordance with the HFPS algorithm.

In this case, the prediction vector computation unit 321 may compute the pMV with the accuracy of a half pixel in a range of −15 to +15.

In this case, the real vector computation unit 322 may compute the rMV using the MVD and the pMV.

For example, the real vector computation unit 322 may compute the rMV using the sum of the MVD and the pMV.

The error concealment unit 330 conceals an error in the video frame using the rMV.

In this case, the error concealment unit 330 may transfer the video frame, in which the error has been concealed, to the video frame provision unit 420.

In this case, if the target macro block of the current frame is a 16×16 block, the 8×8 vector computation unit 323 may compute the 8×8 motion vector of each of four 8×8 blocks that are included in the 16×16 block without overlapping each other.

In this case, the surrounding pixels of the 8×8 block within the target macro block of the current frame may have been obtained by the entropy decoding unit 410.

In this case, the 8×8 vector computation unit 323 may compute the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

In this case, the 8×8 motion vector for which the SAD between the surrounding pixels of the 8×8 block of the current frame and the surrounding pixels of the motion-compensated 8×8 block of the previous frame is a minimum value may be expressed by Equation 9.

In this case, the information acquisition unit 310 may obtain an information bit from the video frame in which the information bit, including any one of the MVD and an 8×8 mode identifier corresponding to the 8×8 motion vector, has been inserted into the QDCT coefficients according to a distortion cost and on which encoding has been performed.

In this case, if the information bit includes the MVD, the vector computation unit 320 may compute the pMV and the rMV.

In this case, if the information bit includes the 8×8 mode identifier, the vector computation unit 320 may compute the 8×8 motion vector.

In this case, if the information bit includes the 8×8 mode identifier, the error concealment unit 330 may conceal an error in the video frame using the 8×8 motion vector.

The video frame provision unit 420 transfers the video frame, in which the error has been concealed, to a user.

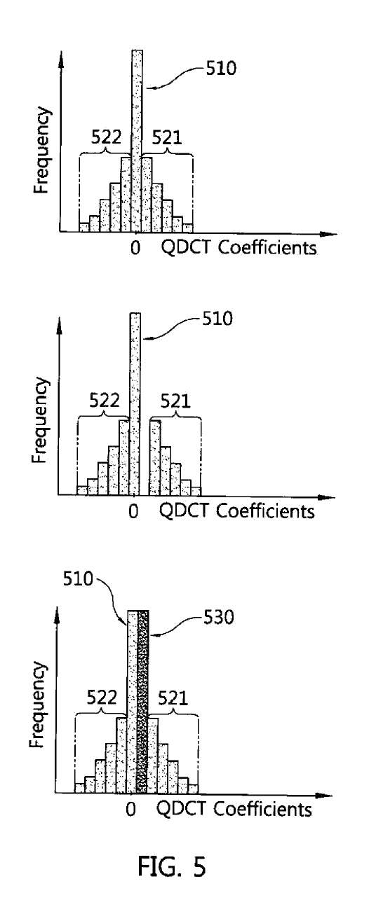

FIG. 5 is a diagram illustrating an example in which the information insertion unit 130 of FIG. 1 inserts an information bit into DCT coefficients.

Referring to FIG. 5, the information insertion unit 130 illustrated in FIG. 1 inserts an information bit 530 between a DC coefficient 510 and AC coefficients 521 and 522 that belong to QDCT coefficients.

For example, the information insertion unit 130 illustrated in FIG. 1 may form a gap between the DC coefficient 510 and the positive AC coefficients 521 by shifting the positive AC coefficients 521 to the right, and may insert the information bit 530 into the gap.

For another example, although not illustrated in FIG. 5, the information insertion unit 130 illustrated in FIG. 1 may form a gap between the DC coefficient 510 and the negative AC coefficients 522 by shifting the negative AC coefficients 522 to the left, and may insert the information bit 530 into the gap.

In some embodiments, the information insertion unit 130 illustrated in FIG. 1 may form a gap at the half-way point of the AC coefficients 521 and 522 in the same way, and may insert the information bit 530 into the gap.

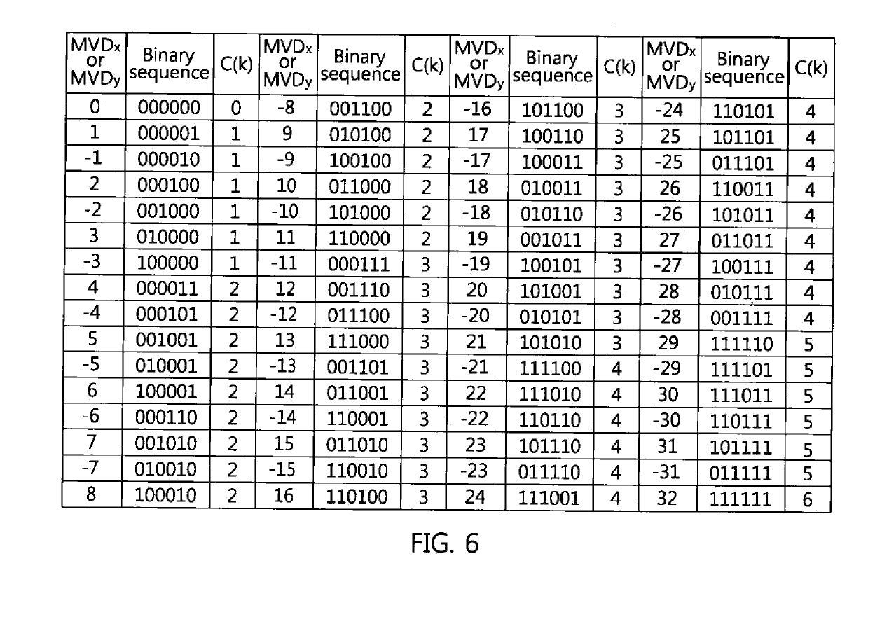

FIG. 6 is a diagram illustrating an example of the binary sequences of MVDs according to an embodiment of the present invention.

From FIG. 6, it may be seen that the binary sequences of MVDs according to this embodiment of the present invention have a one-to-one correspondence relationship with the MVDs.

It may also be seen that in the binary sequences of the MVDs according to this embodiment of the present invention, the number of “1” bits C(k) within each binary sequence is set to a value that decreases as the absolute value of each of the MVDs decreases.

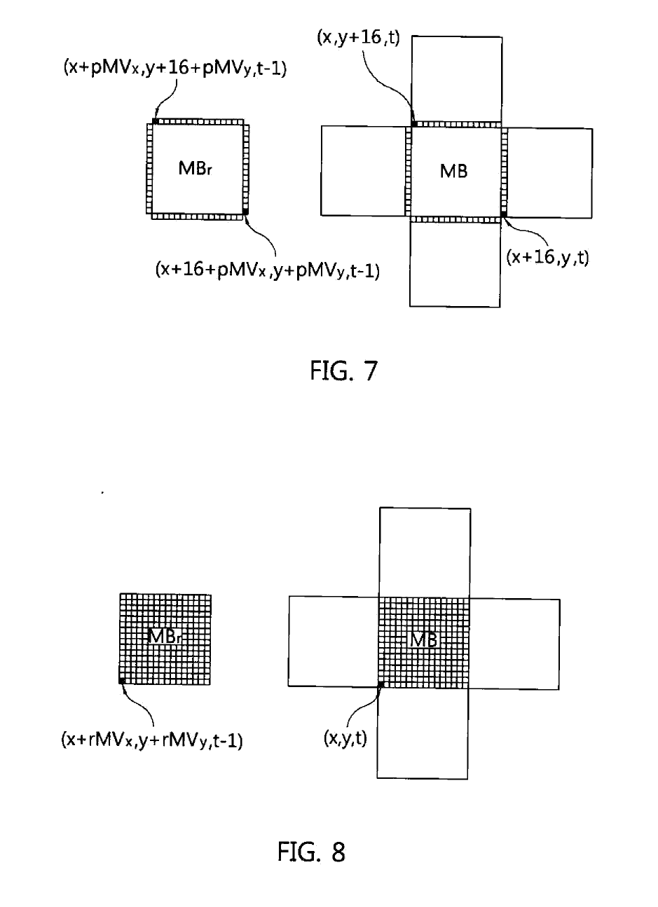

FIG. 7 is a diagram illustrating an example of the surrounding pixels of a 16×16 block according to an embodiment of the present invention.

From FIG. 7, it may be seen that the surrounding pixels of the 16×16 block according to this embodiment of the present invention are the surrounding pixels of a target macro block of a current frame.

In FIG. 7, MB denotes a target macro block of the current frame, and MB, denotes a motion-compensated block of the previous frame.

It may be seen that the MBᵣ has been shifted from the MB by a difference of pMV (pMVₓ, pMV_{y}).

In this case, the prediction vector computation unit 111 illustrated in FIG. 2 may compute the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

That is, referring to FIG. 7 and Equation 1, the prediction vector computation unit 111 illustrated in FIG. 2 computes the pMV using the SAD between the values of the surrounding pixels of the 16×16 block, that is, the target macro block of the current frame, and the values of the surrounding pixels of the 16×16 block, that is, the motion-compensated block of the previous frame.

FIG. 8 is a diagram illustrating an example of the internal pixels of a 16×16 block according to an embodiment of the present invention.

From FIG. 8, it may be seen that the internal pixels of the 16×16 block according to this embodiment of the present invention are the internal pixels of the target macro block of the current frame.

In FIG. 8, MB denotes the target macro block of the current frame, and MBᵣ denotes a motion-compensated block of the previous frame.

In this case, it may be seen that the MBᵣ has been shifted from the MB by a difference of an rMV(rMVₓ,rMV_{y}).

In this case, the real vector computation unit 112 illustrated in FIG. 2 may compute the rMV for which the SAD between the internal pixels of the target macro block of the current frame and the internal pixels of the motion-compensated block of the previous frame is smaller than a predetermined distortion threshold.

In this case, the SAD between the internal pixels of the target macro block of the current frame and the internal pixels of the motion-compensated block of the previous frame may be expressed by Equation 3.

That is, referring to FIG. 8 and Equation 3, the real vector computation unit 112 illustrated in FIG. 2 computes the rMV using the SAD between the values of the internal pixels of the 16×16 block, that is, the target macro block of the current frame, and the values of the internal pixels of the 16×16 block, that is, the motion-compensated block of the previous frame.

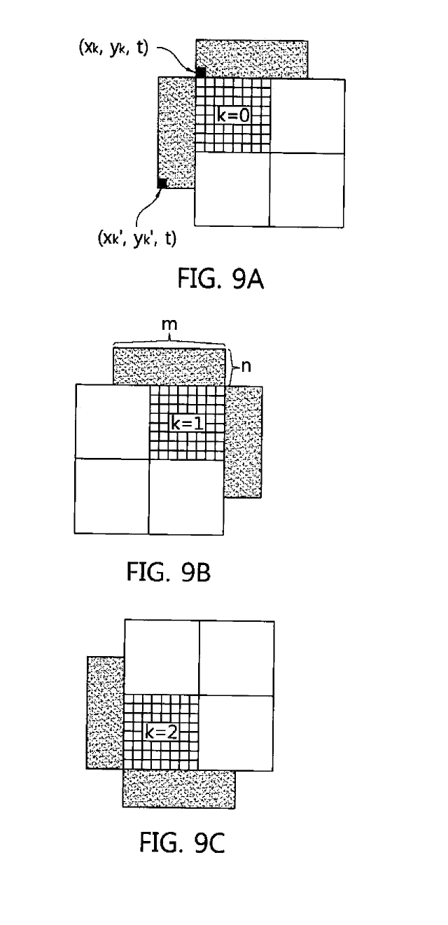

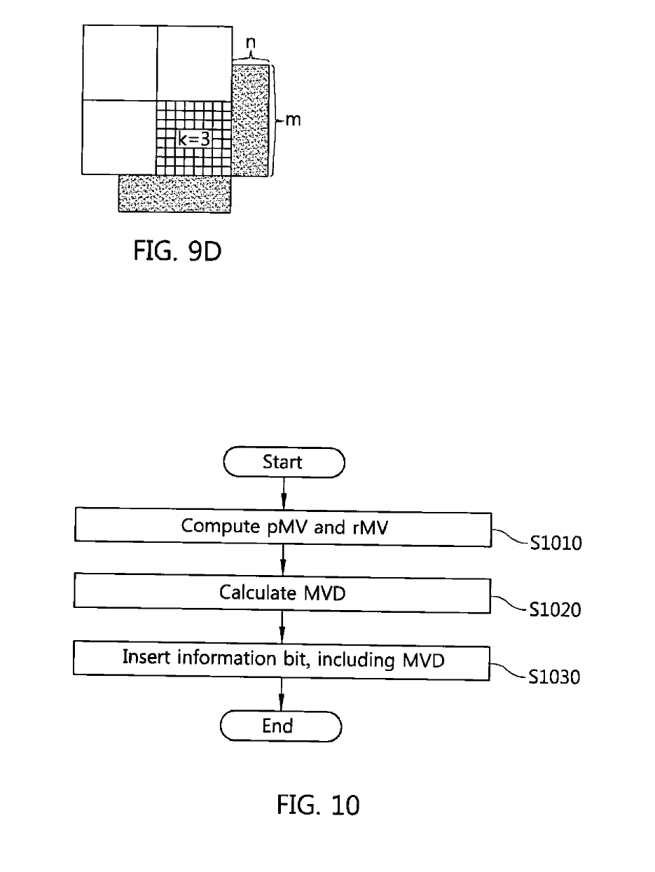

FIGS. 9A to 9D are diagrams illustrating examples of the surrounding pixels of 8×8 blocks according to an embodiment of the present invention.

From FIGS. 9A to 9D, it may be seen that the surrounding pixels of the 8×8 blocks according to this embodiment of the present invention are the surrounding pixels of four 8×8 blocks that are included in a 16×16 block without overlapping each other if a target macro block is the 16×16 block.

In FIGS. 9A to 9D, k denotes an index used to distinguish 8×8 motion vectors in raster scan order, and each of m and n denotes the length of an integer that determines the range of surrounding pixels of the 8×8 block.

k may be any one of 0, 1, 2, and 3.

For example, m may be 10, and n may be 5.

In this case, the 8×8 vector computation unit 113 illustrated in FIG. 2 may compute the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

That is, referring to FIGS. 9A to 9D and Equation 8, the 8×8 vector computation unit 113 illustrated in FIG. 2 computes the 8×8 motion vector using the SAD between the values of the surrounding pixels of the 8×8 block of the current frame and the values of the surrounding pixels of the motion-compensated 8×8 block of the previous frame.

FIG. 10 is a flowchart illustrating an encoding method of concealing an error in a video frame according to an embodiment of the present invention.

Referring to FIG. 10, the encoding method of concealing an error in a video frame according to this embodiment of the present invention includes computing a pMV and an rMV using a target macro block of a current frame and a motion-compensated block of a previous frame at step S1010.

Step S1010 may include computing the pMV using the SAD between the surrounding pixels of the target macro block of the current frame and the internal pixels of the motion-compensated block of the previous frame, and computing the rMV using the SAD between the internal pixels of the target macro block of the current frame and the internal pixels of the motion-compensated block of the previous frame.

Computing the pMV may include computing the pMV by taking into consideration whether or not the SAD between the surrounding pixels of the target macro block of the current frame and the surrounding pixels of the motion-compensated block of the previous frame is a minimum value.

In this case, the surrounding pixels of the target macro block of the current frame and the surrounding pixels of the motion-compensated block of the previous frame may have been obtained by the video frame pre-processing unit 210.

In this case, computing the pMV may include computing the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

In this case, the pMV for which the SAD between the surrounding pixels of the target macro block of the current frame and the surrounding pixels of the motion-compensated block of the previous frame is a minimum value may be expressed by Equation 2.

In this case, computing the pMV may include computing the pMV in accordance with the HFPS algorithm.

In this case, computing the pMV may include computing the pMV with the accuracy of a half pixel in a range of −15 to +15.

Furthermore, computing the rMV may include computing the rMV by taking into consideration whether or not the SAD between the internal pixels of the target macro block of the current frame and the internal pixels of the motion-compensated block of the previous frame is smaller than a predetermined distortion threshold.

In this case, the internal pixels of the target macro block of the current frame and the internal pixels of the motion-compensated block of the previous frame may have been obtained by the video frame pre-processing unit 210.

In this case, computing the rMV may include computing the rMV for which the SAD between the internal pixels of the target macro block of the current frame and the internal pixels of the motion-compensated block of the previous frame is smaller than a predetermined distortion threshold.

In this case, the SAD between the internal pixels of the target macro block of the current frame and the internal pixels of the motion-compensated block of the previous frame may be expressed by Equation 3.

In this case, the rMV for which the SAD between the internal pixels of the target macro block of the current frame and the internal pixels of the motion-compensated block of the previous frame is smaller than the predetermined distortion threshold may be expressed by Equation 4.

In this case, computing the rMV may include computing the rMV by further taking into consideration whether or not the number of “1” bits within the binary sequence of an MVD is a minimum value.

In this case, R in Equation 4 may be expressed by Equation 5.

In this case, the number of “1” bits within the binary sequence of the MVD may have a one-to-one correspondence relationship with the MVD.

In this case, computing the rMV may include computing the rMV in accordance with the HFPS algorithm.

In this case, computing the rMV may include computing the rMV with the accuracy of a half pixel in a range of −15 to +15.

The encoding method of concealing an error in a video frame according to this embodiment of the present invention further includes computing the MVD using the difference between the pMV and the rMV at step S1020.

In this case, the MVD may be expressed by Equation 6.

The encoding method of concealing an error in a video frame according to this embodiment of the present invention further includes inserting an information bit, including the MVD, into the QDCT coefficients of the video frame at step S1030.

In this case, the QDCT coefficients may have been obtained by the video frame pre-processing unit. 210

In this case, the QDCT coefficients may have been rearranged in a zigzag pattern by the video frame pre-processing unit 210.

At step S1030, the information bit may be inserted between DC and AC coefficients that belong to the QDCT coefficients.

In this case, the DC coefficient may be a coefficient that belongs to the QDCT coefficients and that has a frequency of 0.

In this case, the AC coefficient may be a coefficient that belongs to the QDCT coefficients and that does not have a frequency of 0.

In this case, the QDCT coefficient may be a coefficient corresponding to the frequency parameter of DCT.

In this case, if the QDCT coefficient is C and the frequency parameter of the DCT is k, the QDCT coefficient corresponding to the frequency parameter may be C(k).

In this case, the DC coefficient may be C(0).

In this case, the AC coefficient may be C(k) in which k is not 0.

At step S1030, the information bit may be inserted into the QDCT coefficients using a histogram shift-based reversible data concealment scheme.

At step S1030, if a frequency parameter is a positive number, the frequency parameter may be set so that it is increased by 1, the frequency parameter of the information bit may be set so that it becomes 1, and the information bit may be inserted between the DC and AC coefficients. This may be expressed by Equation 7.

As described above, at step S1030, in accordance with Equation 7, k may be set so that it is increased by 1 if k is a positive number and a value corresponding to k is the QDCT coefficient, k may be set so that it becomes 1 if the value corresponding to k is the information bit, and the information bit may be inserted between the DC and AC coefficients.

In this case, at step S1030, the QDCT coefficients, into which the information bit has been inserted, may be transferred to the entropy encoding unit 220.

In this case, the entropy encoding unit 220 may encode the QDCT coefficients, into which the information bit has been inserted, using the chessboard pattern mode of FMO with respect to H.264/AVC.

In this case, step S1010 may further include computing an 8×8 motion vector using the surrounding pixels of an 8×8 block within the target macro block of the current frame.

In this case, the surrounding pixels of the 8×8 block within the target macro block of the current frame may have been obtained by the video frame pre-processing unit 210.

In this case, if the target macro block of the current frame is a 16×16 block, computing the 8×8 motion vector may include computing the 8×8 motion vector of each of four 8×8 blocks that are included in the 16×16 block without overlapping each other.

In this case, computing the 8×8 motion vector may include computing the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

In this case, the 8×8 motion vector for which the SAD between the surrounding pixels of the 8×8 block of the current frame and the surrounding pixels of the motion-compensated 8×8 block of the previous frame is a minimum value may be expressed by Equation 9.

Although not illustrated in FIG. 10, the encoding method of concealing an error in a video frame according to this embodiment of the present invention may further include computing the distortion cost of the rMV and the 8×8 motion vector.

In this case, calculating the distortion cost may include calculating a distortion cost in an MVD E mode using the SAD of the rMV.

The distortion cost in an MVD E mode may be expressed by Equation 10.

In this case, calculating the distortion cost may include calculating a distortion cost in an MVD NE mode using the SAD of the 8×8 motion vector.

The distortion cost in an MVD NE mode may be expressed by Equation 11.

In this case, at step S1030, the information bit including any one of the MVD and an 8×8 mode identifier corresponding to the 8×8 motion vector may be inserted into the QDCT coefficients based on the distortion cost.

At step S1030, if the distortion cost in an MVD E mode is higher than the distortion cost in an MVD NE mode, the information bit including the MVD may be inserted into the QDCT coefficients.

At step S1030, if the distortion cost in an MVD E mode is lower than the distortion cost in an MVD NE mode, the information bit, including an 8×8 mode identifier corresponding to the 8×8 motion vector, may be inserted into the QDCT coefficients.

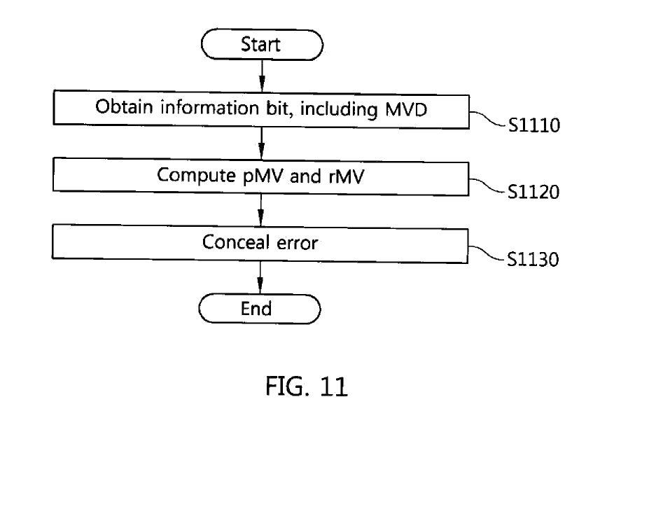

FIG. 11 is a flowchart illustrating a decoding method of concealing an error in a video frame according to an embodiment of the present invention.

Referring to FIG. 11, the decoding method of concealing an error in a video frame according to this embodiment of the present invention includes obtaining an information bit from a video frame into which the information bit including an MVD has been inserted into QDCT coefficients and on which encoding has been performed at step S1110.

In this case, the information bit may have been obtained by the entropy decoding unit 410.

The decoding method of concealing an error in a video frame according to an embodiment of the present invention further includes computing a pMV and an rMV using the target macro block of a current frame, a motion-compensated block of a previous frame, and the MVD at step S1120.

Step S1120 may include computing the pMV using the SAD between the surrounding pixels of the target macro block of the current frame and the internal pixels of the motion-compensated block of the previous frame and computing the rMV using the sum of the pMV and the MVD.

Computing the pMV may include computing the pMV by taking into consideration whether or not the SAD between the surrounding pixels of the target macro block of the current frame and the surrounding pixels of the motion-compensated block of the previous frame is a minimum value.

In this case, the surrounding pixels of the target macro block of the current frame and the surrounding pixels of the motion-compensated block of the previous frame may have been obtained by the entropy decoding unit 410.

Computing the pMV may include computing the pMV for which the SAD between the surrounding pixels of the target macro block of the current frame and the surrounding pixels of the motion-compensated block of the previous frame is a minimum value.

In this case, the SAD between the surrounding pixels of the target macro block of the current frame and the surrounding pixels of the motion-compensated block of the previous frame may be expressed by Equation 1.

In this case, the pMV for which the SAD between the surrounding pixels of the target macro block of the current frame and the surrounding pixels of the motion-compensated block of the previous frame is a minimum value may be represented as in Equation 2.

In this case, computing the pMV may include computing the pMV in accordance with the HFPS algorithm.

Furthermore, computing the pMV may include computing the pMV with the accuracy of a half pixel in a range of −15 to +15.

In this case, computing the rMV may include computing the rMV using the MVD and the pMV.

For example, computing the rMV may include computing the rMV by adding the MVD and the pMV.

The decoding method of concealing an error in a video frame according to an embodiment of the present invention further includes performing the concealment of an error in the video frame using the rMV at step S1130.

At step S1130, the video frame in which the error has been concealed may be transferred to the video frame provision unit 420.

Step S1120 may further include determining whether or not an 8×8 mode identifier is included in the information bit and computing the 8×8 motion vector using the surrounding pixels of the target macro block of the current frame if, as a result of the determination, it is determined that the 8×8 mode identifier is included in the information bit.

If the target macro block of the current frame is a 16×16 block, computing the 8×8 motion vector may include computing the 8×8 motion vector of each of four 8×8 blocks that are included in the 16×16 block without overlapping each other.

In this case, the surrounding pixels of an 8×8 block within the target macro block of the current frame may have been obtained by the entropy decoding unit 410.

In this case, computing the 8×8 motion vector may include computing the 8×8 motion vector for which the SAD between the surrounding pixels of the 8×8 block of the current frame and the surrounding pixels of the motion-compensated 8×8 block of the previous frame is a minimum value.

In this case, the SAD between the surrounding pixels of the 8×8 block of the current frame and the surrounding pixels of the motion-compensated 8×8 block of the previous frame may be expressed by Equation 8.

In this case, the 8×8 motion vector for which the SAD between the surrounding pixels of the 8×8 block of the current frame and the surrounding pixels of the motion-compensated 8×8 block of the previous frame is a minimum value may be expressed by Equation 9.

In this case, at step S1110, the information bit may be obtained from a video frame in which the information bit, including any one of the MVD and an 8×8 mode identifier corresponding to the 8×8 motion vector, has been inserted into the QDCT coefficients based on a distortion cost and on which encoding has been performed.

In this case, if the information bit includes the MVD, step S1120 may include computing the pMV and the rMV.

In this case, if the information bit includes the 8×8 mode identifier, step S1120 may include computing the 8×8 motion vector.

In this case, if the information bit includes the 84 mode identifier, step S1130 may include performing the concealment of an error in the video frame using the 8×8 motion vector.

As described above, an embodiment of the present invention enables video frame encoding/decoding capable of reducing a bit increase rate attributable to the insertion of reversible data using an MVD in video frame error concealment.

Furthermore, an embodiment of the present invention enables video frame encoding/decoding capable of reducing a bit increase rate attributable to the insertion of reversible data by inserting an MVD into QDCT coefficients.

Furthermore, an embodiment of the present invention enables video frame encoding/decoding capable of reducing a bit increase rate attributable to the insertion of reversible data by inserting an MVD between DC and AC coefficients that belong to QDCT coefficients.

Furthermore, an embodiment of the present invention enables more precise video frame encoding/decoding by performing error concealment using 84 mode if a distortion cost in 16×16 mode is high.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An encoding apparatus for concealing an error in a video frame, comprising:
a vector computation unit configured to compute a predicted motion vector (pMV) and a real motion vector (rMV) using a target macro block of a current frame and a motion-compensated block of a previous frame;
a difference computation unit configured to calculate a motion vector difference (MVD) using a difference between the pMV and the rMV; and
an information insertion unit configured to insert an information bit, including the MVD, into quantized discrete cosine transform (QDCT) coefficients of the video frame.

2. The encoding apparatus of claim 1, wherein the vector computation unit comprises:
a prediction vector computation unit configured to compute the pMV using a sum of absolute differences (SAD) between surrounding pixels of the target macro block of the current frame and internal pixels of the motion-compensated block of the previous frame; and
a real vector computation unit configured to compute the rMV using an SAD between internal pixels of the target macro block of the current frame and the internal pixels of the motion-compensated block of the previous frame.

3. The encoding apparatus of claim 2, wherein the prediction vector computation unit computes the pMV by taking into consideration whether or not an SAD between the surrounding pixels of the target macro block of the current frame and surrounding pixels of the motion-compensated block of the previous frame is a minimum value.

4. The encoding apparatus of claim 3, wherein the real vector computation unit computes the rMV by taking into consideration whether or not the SAD between the internal pixels of the target macro block of the current frame and the internal pixels of the motion-compensated block of the previous frame is smaller than a predetermined distortion threshold.

5. The encoding apparatus of claim 4, wherein the real vector computation unit computes the rMV by further taking into consideration whether or not a number of “1” bits within a binary sequence of the MVD is a minimum value.

6. The encoding apparatus of claim 4, wherein:
the vector computation unit further comprises an 8×8 vector computation unit configured to compute an 8×8 motion vector using surrounding pixels of an 8×8 block within the target macro block of the current frame;
the encoding apparatus further comprises a distortion cost calculation unit configured to calculate a distortion cost of the rMV and the 8×8 motion vector; and
the information insertion unit inserts the information bit, including any one of the MVD and an 8×8 mode identifier corresponding to the 8×8 motion vector, into the QDCT coefficients based on the distortion cost.

7. The encoding apparatus of claim 4, wherein the information insertion unit inserts the information bit between DC and AC coefficients that belong to the QDCT coefficients.

8. A decoding apparatus for concealing an error in a video frame, comprising:
an information acquisition unit configured to obtain an information bit from the video frame in which the information bit, including a motion vector difference (MVD), has been inserted into quantized discrete cosine transform (QDCT) coefficients and on which encoding has been performed;
a vector computation unit configured to compute a predicted motion vector (pMV) and a real motion vector (rMV) using a target macro block of a current frame, a motion-compensated block of a previous frame, and the MVD; and
an error concealment unit configured to perform the concealment of the error in the video frame using the rMV.

9. The decoding apparatus of claim 8, wherein the vector computation unit comprises:
a prediction vector computation unit configured to compute the pMV using a sum of absolute differences (SAD) between surrounding pixels of the target macro block of the current frame and internal pixels of the motion-compensated block of the previous frame; and
a real vector computation unit configured to compute the rMV using a sum of the pMV and the MVD.

10. The decoding apparatus of claim 9, wherein:
the information acquisition unit determines whether or not an 8×8 mode identifier is included in the information bit;
the vector computation unit further comprise an 8×8 vector computation unit configured to compute an 8×8 motion vector using the surrounding pixels of the target macro block of the current frame if, as a result of the determination, it is determined that the 8×8 mode identifier is included in the information bit; and
the error concealment unit conceals the error in the video frame using the 84 motion vector if, as a result of the determination, it is determined that the 8×8 mode identifier is included in the information bit.

11. An encoding method for concealing an error in a video frame, comprising:
computing a predicted motion vector (pMV) and a real motion vector (rMV) using a target macro block of a current frame and a motion-compensated block of a previous frame;
calculating a motion vector difference (MVD) using a difference between the pMV and the rMV; and
inserting an information bit, including the MVD, into quantized discrete cosine transform (QDCT) coefficients of the video frame.

12. The encoding method of claim 11, wherein computing the pMV and the rMV comprises:
computing the pMV using a sum of absolute differences (SAD) between surrounding pixels of the target macro block of the current frame and internal pixels of the motion-compensated block of the previous frame; and
computing the rMV using an SAD between internal pixels of the target macro block of the current frame and the internal pixels of the motion-compensated block of the previous frame.

13. The encoding method of claim 12, wherein computing the pMV and the rMV further comprises computing the pMV by taking into consideration whether or not an SAD between the surrounding pixels of the target macro block of the current frame and surrounding pixels of the motion-compensated block of the previous frame is a minimum value.

14. The encoding method of claim 13, wherein computing the pMV and the rMV comprises computing the rMV by taking into consideration whether or not the SAD between the internal pixels of the target macro block of the current frame and the internal pixels of the motion-compensated block of the previous frame is smaller than a predetermined distortion threshold.

15. The encoding method of claim 14, wherein computing the pMV and the rMV comprises computing the rMV by further taking into consideration whether or not a number of “1” bits within a binary sequence of the MVD is a minimum value.

16. The encoding method of claim 14, further comprising:
computing an 8×8 motion vector using surrounding pixels of an 8×8 block within the target macro block of the current frame; and
calculating a distortion cost of the rMV and the 8×8 motion vector;
wherein inserting the information bit comprises inserting the information bit, including any one of the MVD and an 8×8 mode identifier corresponding to the 8×8 motion vector, into the QDCT coefficients based on the distortion cost.

17. The encoding method of claim 14, wherein inserting the information bit comprises inserting the information bit between DC and AC coefficients that belong to the QDCT coefficients.
